(19) United States
(12) Patent Application Publication
(10) Pub. No.: US 2018/0169896 A1
(43) Pub. Date: Jun. 21, 2018

(54) MANUFACTURING METHOD OF HONEYCOMB STRUCTURE

(71) Applicant: NGK INSULATORS, LTD., Nagoya-City (JP)

(72) Inventors: Yuta Imaizumi, Nagoya-City (JP); Kazuhiko Hamatsuka, Nagoya-City (JP)

(73) Assignee: NGK INSULATORS, LTD., Nagoya-City (JP)

(21) Appl. No.: 15/830,372

(22) Filed: Dec. 4, 2017

(30) Foreign Application Priority Data
Dec. 15, 2016 (JP) 2016-243200

(51) Int. Cl. B28B 3/26; B28B 11/24; C04B 38/00

(52) U.S. Cl. CPC B28B 3/269; B28B 2003/203; C04B 38/0006; B28B 11/243

(57) ABSTRACT

A manufacturing method of a honeycomb structure include a forming step of extruding a kneaded material including a forming raw material by use of a horizontal forming machine include a forming die in which latticed slits are formed in a kneaded material discharge surface, to obtain a round pillar-shaped honeycomb formed body having latticed partition walls; and a firing step of firing the obtained honeycomb formed body to prepare the honeycomb structure. In the forming step, there is used the forming die in which there are formed the slits different in lattice shape between a central portion and a circumferential portion in the kneaded material discharge surface, and the forming die is disposed in an orientation in which an inclination of one row of the latticed slits formed in the central portion is within an angle of ±10° to a vertical direction, to extrude the kneaded material in a horizontal direction.

### “The present application is an application based on JP-2016-243200 filed on Dec. 15, 2016 with Japan Patent Office, the entire contents of which are incorporated herein by reference.”

### BACKGROUND OF THE INVENTION

### Field of the Invention

The present invention relates to a manufacturing method of a honeycomb structure, and more particularly, it relates to a manufacturing method of a honeycomb structure which is capable of inhibiting deformation or distortion of a honeycomb formed body and manufacturing the honeycomb structure having an excellent shape accuracy.

### Description of the Related Art

Heretofore, a honeycomb structure onto which a catalyst is loaded has been used for a purifying treatment of toxic substances such as HC, CO and NOₓ included in an exhaust gas emitted from an engine of a car or the like. Furthermore, such a honeycomb structure is also used as an exhaust gas purifying filter by plugging open ends of cells defined and formed by porous partition walls.

The honeycomb structures are pillar-shaped structures each having partition walls defining and forming a plurality of cells which become through channels for the exhaust gas. Such a honeycomb structure has a cell structure in which the plurality of cells are regularly arranged at predetermined cycles in a plane perpendicular to an extending direction of the cells. Heretofore, there has been one type of cell structure in the above plane of one honeycomb structure, but in recent years, there has been suggested a honeycomb structure having two or more types of cell structures in the above plane for the purpose of improvement of an exhaust gas purification efficiency, or the like. For example, there has been suggested a honeycomb structure having two types of cell structures in the above plane, in which a central portion is different from a circumferential portion in cell density or cell shape in the plane perpendicular to the cell extending direction.

This honeycomb structure is manufactured by forming a kneaded material including a ceramic forming raw material with an extruding die to prepare a honeycomb formed body and then drying and firing the prepared honeycomb formed body. For example, the honeycomb structure forming die is prepared by forming, in a die substrate made of a metal, back holes into which the kneaded material is introduced and slits which communicate with the back holes (e.g., see Patent Document 1). Hereinafter, the honeycomb structure forming die will occasionally be referred to simply as “a forming die” or “a die”.

[Patent Document 1] JP-A-H04-332604

### SUMMARY OF THE INVENTION

In extrusion of a honeycomb formed body, there is a case where horizontal extrusion is employed in which an extruding direction is a horizontal direction, and there is another case where vertical extrusion is employed in which the extruding direction is a vertical direction (downward). In the case of forming the honeycomb formed body by the horizontal extrusion, it is necessary to support the honeycomb formed body extruded out from a die in the horizontal direction from the downside with a receiving base having a support surface which comes in contact with a circumferential face of the honeycomb formed body. Furthermore, the honeycomb formed body which has just been extruded out from the die is soft, and hence its circumferential shape is easily deformable.

For the purpose of manufacturing such “a honeycomb structure having two types of cell structures” as described in Patent Document 1, it is necessary to form “a honeycomb formed body having two types of cell structures” by the extrusion. This “honeycomb structure body having two types of cell structures” also has the problem that deformation or distortion occurs in the circumferential shape of the honeycomb formed body. Furthermore, for “the honeycomb formed body having the two types of cell structures”, a central portion and circumferential portion of the obtainable honeycomb formed body might be deformed into different shapes. Consequently, it is remarkably difficult to correct a shape of the deformed honeycomb formed body (i.e., adjust the deformed shape) after the extrusion. For example, in a honeycomb formed body having one type of cell structure, it might be possible to correct the deformation or distortion in the horizontal direction or the vertical direction after the formation. However, for the honeycomb formed body having two types of cell structures, the above-mentioned correction becomes difficult depending on a change/deformation degree of the honeycomb formed body, and hence it is a remarkably important problem to prepare the honeycomb formed body which has an excellent shape accuracy or which is capable of achieving improvement of the shape accuracy by the correction or the like.

The present invention has been developed in view of these problems of conventional technologies. An object of the present invention is to provide a manufacturing method of a honeycomb structure which is capable of inhibiting deformation or distortion of a honeycomb formed body and manufacturing the honeycomb structure having an excellent shape accuracy.

According to the present invention, there is provided a manufacturing method of a honeycomb structure as follows.

[1] A manufacturing method of a honeycomb structure, including:
a forming step of extruding a kneaded material including a forming raw material by use of a horizontal forming machine including a forming die in which latticed slits are formed in a kneaded material discharge surface, to obtain a round pillar-shaped honeycomb formed body having latticed partition walls; and
a firing step of firing the obtained honeycomb formed body to prepare the honeycomb structure,
wherein in the forming step, there is used the forming die in which there are formed the slits different in lattice shape between a central portion and a circumferential portion in the kneaded material discharge surface, and
the forming die is disposed in an orientation in which an inclination of one row of the latticed slits formed in the central portion is within an angle of ±10° to a vertical direction, to extrude the kneaded material in a horizontal direction.

[2] The manufacturing method of the honeycomb structure according to the above [1], wherein in the forming die, each row consisting of the latticed slits formed in the central portion and each row consisting of the latticed slits formed in the circumferential portion do not have a parallel positional relation.

[3] The manufacturing method of the honeycomb structure according to the above [1] or [2], wherein in the forming die, the slits formed in the central portion are quadrangular lattices or hexagonal lattices.

[4] The manufacturing method of the honeycomb structure according to any one of the above [1] to [3], wherein in the forming die, the slits formed in the circumferential portion are quadrangular lattices or hexagonal lattices.

[5] The manufacturing method of the honeycomb structure according to the above [4], wherein in the forming die, one row of the latticed slits formed in the circumferential portion is inclined at an angle in a range of 20 to 55° to one row of the latticed slits formed in the central portion.

[6] The manufacturing method of the honeycomb structure according to any one of the above [1] to [5], wherein in the forming die, a size ratio of an outer diameter of the central portion in the kneaded material discharge surface to a diameter of an end face of the honeycomb formed body to be extruded is from 60 to 80%.

[7] The manufacturing method of the honeycomb structure according to any one of the above [1] to [6], wherein in the forming die, a lattice interval in the slits formed in the central portion is smaller than a lattice interval in the slits formed in the circumferential portion.

A manufacturing method of a honeycomb structure of the present invention produces the effect that it is possible to inhibit deformation or distortion of a honeycomb formed body and to manufacture the honeycomb structure having an excellent shape accuracy. Specifically, in an especially main constitution, a forming die is disposed in an orientation in which an inclination of one row of latticed slits formed in a central portion is within an angle of ±10° to a vertical direction, to extrude a kneaded material in a horizontal direction. When the extrusion is performed by such a method, there is obtainable a honeycomb formed body which has an excellent shape accuracy or which is capable of achieving improvement of the shape accuracy by correction or the like.

### BRIEF DESCRIPTION OF THE DRAWINGS

FIG. 1 is an explanatory view schematically showing a forming step in one embodiment of a manufacturing method of a honeycomb structure of the present invention;

FIG. 2 is an explanatory view schematically showing a state of extruding a honeycomb formed body in the forming step shown in FIG. 1;

FIG. 3 is a front view schematically showing a forming die for use in the forming step shown in FIG. 1;

FIG. 4 is an enlarged front view in which a central portion of the forming die shown in FIG. 3 is enlarged;

FIG. 5 is a cross-sectional view schematically showing a cross section of the forming die shown in FIG. 3 which is parallel to an extruding direction;

FIG. 6 is a perspective view schematically showing a receiving base for use in the forming step shown in FIG. 1;

FIG. 7 is a perspective view schematically showing the honeycomb formed body extruded by the forming step in the one embodiment of the manufacturing method of the honeycomb structure of the present invention;

FIG. 8 is a perspective view schematically showing a honeycomb structure manufactured by the one embodiment of the manufacturing method of the honeycomb structure of the present invention;

FIG. 9 is a plan view schematically showing an inflow end face of the honeycomb structure shown in FIG. 8;

FIG. 10 is a front view schematically showing the forming die for use in a forming step in another embodiment of the manufacturing method of the honeycomb structure of the present invention;

FIG. 11 is an enlarged front view in which a central portion of the forming die shown in FIG. 10 is enlarged;

FIG. 12 shows a schematic perspective view of a honeycomb formed body to explain a measurement region of an outer diameter of a circumferential portion and an outer diameter of a central portion in the honeycomb formed body;

FIG. 13 is a cross-sectional view showing a cross section of the honeycomb formed body shown in FIG. 12 which is perpendicular to a cell extending direction;

FIG. 14 is a front view schematically showing a forming die for use in a forming step of a manufacturing method of a honeycomb structure of Comparative Example 1;

FIG. 15 is an enlarged front view in which a central portion of the forming die shown in FIG. 14 is enlarged;

FIG. 16 is a graph showing dimensional differences from standard values in a honeycomb formed body extruded in a manufacturing method of a honeycomb structure of Example 1; and

FIG. 17 is a graph showing dimensional differences from standard values in a honeycomb formed body extruded in a manufacturing method of a honeycomb structure of Comparative Example 1.

### DESCRIPTION OF THE PREFERRED EMBODIMENT

Hereinafter, description will be made as to embodiments of the present invention. However, the present invention is not limited to the following embodiments. Therefore, it should be understood that changes, improvements and the like are suitably addable to the following embodiments on the basis of ordinary knowledge of a person skilled in the art without departing from the gist of the present invention.

### (1) Manufacturing Method of Honeycomb Structure

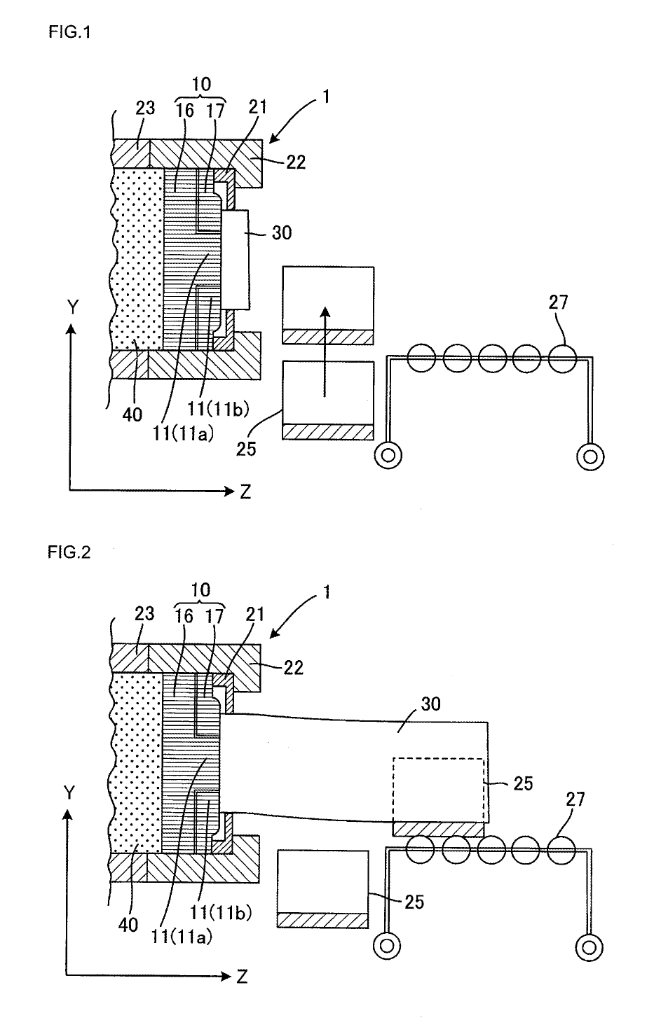

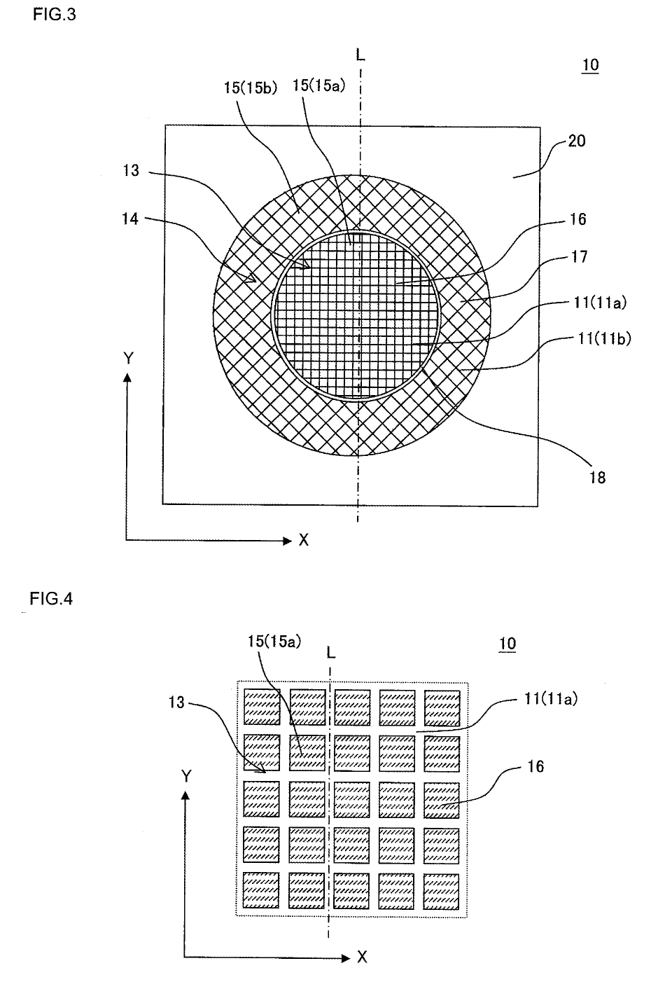

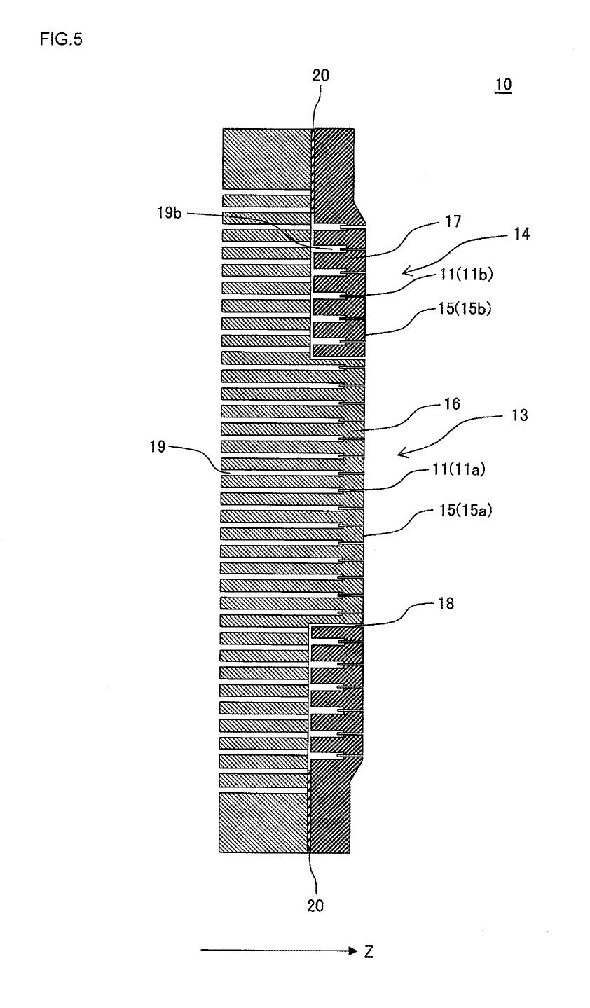

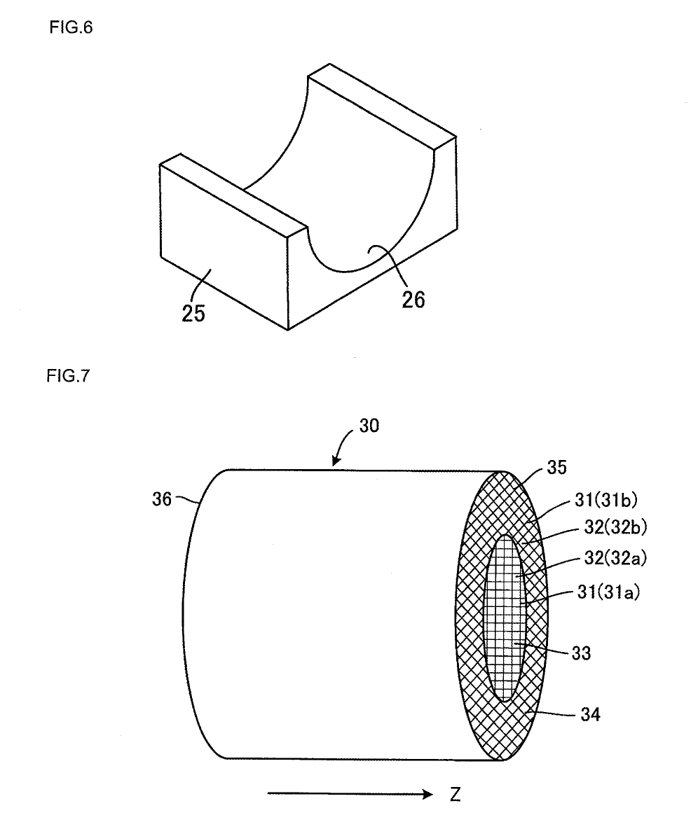

FIG. 1 is an explanatory view schematically showing a forming step in one embodiment of a manufacturing method of a honeycomb structure of the present invention. FIG. 2 is an explanatory view schematically showing a state of extruding a honeycomb formed body in the forming step shown in FIG. 1. FIG. 3 is a front view schematically showing a forming die for use in the forming step shown in FIG. 1. FIG. 4 is an enlarged front view in which a central portion of the forming die shown in FIG. 3 is enlarged. FIG. 5 is a cross-sectional view schematically showing a cross section of the forming die shown in FIG. 3 which is parallel to an extruding direction. FIG. 6 is a perspective view schematically showing a receiving base for use in the forming step shown in FIG. 1. FIG. 7 is a perspective view schematically showing the honeycomb formed body extruded by the forming step in the one embodiment of the manufacturing method of the honeycomb structure of the present invention.

The manufacturing method of the honeycomb structure of the present embodiment includes a forming step and a firing step. As shown in FIG. 1 and FIG. 2, the forming step is a step of extruding a kneaded material 40 including a forming raw material by use of a horizontal forming machine 1 including a forming die 10 in which latticed slits 11 are formed in a kneaded material discharge surface, to obtain a round pillar-shaped honeycomb formed body 30 having latticed partition walls.

The manufacturing method of the honeycomb structure of the present embodiment has characteristics in such a forming step as shown in FIG. 1 to FIG. 5. Hereinafter, the manufacturing method of the honeycomb structure of the present embodiment will occasionally be referred to simply as “the manufacturing method of the present embodiment”. In the manufacturing method of the present embodiment, in the forming step, there is used the forming die 10 in which there are formed slits 11a and 11b different in lattice shape between a central portion 13 and a circumferential portion 14 in a kneaded material discharge surface 15. Then, the forming die 10 is disposed in an orientation in which an inclination of one row of the latticed slits 11a formed in the central portion 13 is within an angle of ±10° to a vertical direction, to extrude the kneaded material 40 in a horizontal direction.

In the manufacturing method of the present embodiment, the extrusion is performed by using the forming die 10 in which there are formed the slits 11a and 11b different in lattice shape between the central portion 13 and the circumferential portion 14 in the kneaded material discharge surface 15, and hence the honeycomb formed body 30 has two types of cell structures. That is, as shown in FIG. 7, the honeycomb formed body 30 is a formed body in which latticed partition walls 31 define and form a plurality of cells 32 extending from a first end face 35 to a second end face 36. In the honeycomb formed body 30, there are arranged the partition walls 31 different in lattice shape between a central portion 33 and a circumferential portion 34. Consequently, in the honeycomb formed body 30, the cell structure of the central portion 33 is different from that of the circumferential portion 34. In FIG. 7, reference numeral 31a denotes the partition walls 31 of the central portion 33 and reference numeral 31b denotes the partition walls 31 of the circumferential portion 34. Furthermore, reference numeral 32a denotes the cells 32 of the central portion 33 and reference numeral 32b denotes the cells 32 of the circumferential portion 34.

In FIG. 3 and FIG. 4, a one-dot chain line denoted with symbol L indicates an extending direction of one row of the latticed slits 11a of the central portion 13 (i.e., an orientation of the one row of the slits 11a of the central portion 13). Furthermore, in FIG. 1 to FIG. 4, an arrow denoted with symbol Y indicates a vertical direction. In FIG. 1, FIG. 2, FIG. 5 and FIG. 7, an arrow denoted with symbol Z indicates an extruding direction of the kneaded material 40. In FIG. 3 and FIG. 4, an arrow denoted with symbol X indicates a direction perpendicular to the vertical direction and the extruding direction.

In the present description, “the cell structure” is a structure formed by a set of repeating units, and one repeating unit corresponds to one cell or a combination of a plurality of cells in a plane perpendicular to the extending direction of the cells. For example, when the cells having the same shape are regularly arranged in the above plane, a region where the cells having the same shape are present becomes one cell structure. Furthermore, when a combination of a plurality of cells having different cell shapes constitutes one repeating unit, a region where the repeating unit is present also constitutes one cell structure.

When it is described that two cell structures are “different cell structures”, it is meant that in the case of comparison of the two cell structures, the structures are different in at least one of a partition wall thickness, a cell density and a cell shape. Here, when “the structures are different in partition wall thickness”, it is meant that in the case of the comparison of the partition wall thicknesses of the two cell structures, there is a difference of 25 μm or more. Furthermore, when “the structures are different in cell density”, it is meant that in the case of the comparison of the cell densities of the two cell structures, there is a difference of 7 cells/cm² or more.

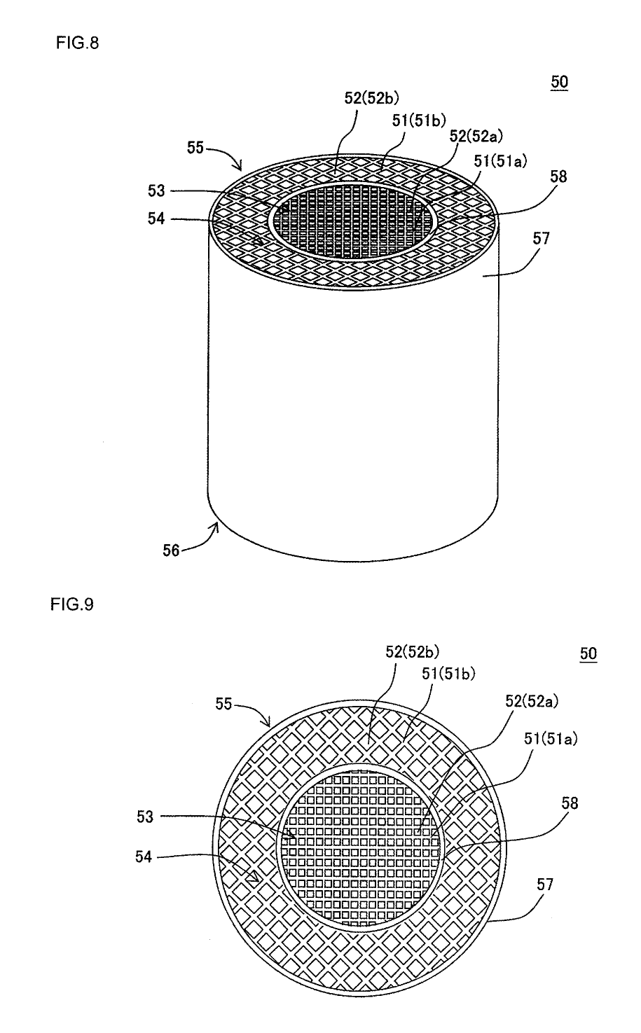

The firing step is a step of firing the obtained honeycomb formed body 30 (see FIG. 7) to prepare such a honeycomb structure 50 as shown in FIG. 8 and FIG. 9. It is to be noted that the firing step can be performed in conformity with a firing step in a heretofore known manufacturing method of the honeycomb structure. Here, FIG. 8 is a perspective view schematically showing the honeycomb structure manufactured by the one embodiment of the manufacturing method of the honeycomb structure of the present invention. FIG. 9 is a plan view schematically showing an inflow end face of the honeycomb structure shown in FIG. 8.

In the manufacturing method of the present embodiment, the forming step of extruding the kneaded material 40 is performed by the above-mentioned method, so that it is possible to inhibit deformation or distortion of the honeycomb formed body 30 (see FIG. 7) and to manufacture the honeycomb structure 50 (see FIG. 8) having an excellent shape accuracy. That is, in the manufacturing method of the present embodiment, there is obtainable the honeycomb formed body 30 (see FIG. 7) which has the excellent shape accuracy or which is capable of achieving improvement of the shape accuracy by correction or the like, and hence it is possible to manufacture the honeycomb structure 50 (see FIG. 8) having the excellent shape accuracy.

More specifically, in such a formed step as shown in FIG. 1 to FIG. 7, the extrusion is performed so that the one row of the latticed slits 11a formed in the central portion 13 of the forming die 10 is oriented in the vertical direction, whereby it is possible to effectively inhibit the deformation or distortion of the honeycomb formed body 30. Particularly in the extrusion, it is important that diameters of the central portion and circumferential portion of the obtainable honeycomb formed body fall within predetermined dimensional tolerances. Hereinafter, “the diameters which fall within the predetermined dimensional tolerances” will be referred to as “standard values”, and in the extrusion, the honeycomb formed body occasionally has “the standard values” corresponding to the shapes of the slits 11 of the forming die 10. Then, for example, in the honeycomb formed body having different cell structures, “the standard values” are occasionally provided for the diameter of the central portion and the diameter of the circumferential portion, respectively. According to the forming step in the manufacturing method of the present embodiment, it is possible to perform the extrusion so that a dimensional difference (i.e., deviation) between each of the diameters of the central portion and circumferential portion of the honeycomb formed body and each standard value further decreases. For example, when the honeycomb formed body has a boundary wall defining the circumferential portion and the central portion, the diameter of the central portion can be defined as an outer diameter of this boundary wall. Furthermore, the diameter of the circumferential portion can be defined as an outer diameter of the honeycomb formed body.

Furthermore, when the inclination of the one row of the latticed slits 11a formed in the central portion 13 of the forming die 10 is within the angle of ±10° to the vertical direction, the same degree of effect as the above-mentioned effect of inhibiting the deformation or distortion of the honeycomb formed body is obtainable. Consequently, in the manufacturing method of the present embodiment, the forming die 10 is disposed in the orientation in which the inclination of the one row of the latticed slits 11a formed in the central portion 13 is within the angle of ±10° to the vertical direction, to perform the extrusion.

When the extrusion is performed in a state where the inclination of each row of the latticed slits 11a formed in the central portion 13 of the forming die 10 is in excess of the angle of ±10° to the vertical direction, the deviation between each of the diameters of the central portion and circumferential portion of the honeycomb formed body and each standard value increases. In particular, the central portion and circumferential portion of the honeycomb formed body 30 are deformed to expand in the direction X (e.g., see FIG. 3) perpendicular to the vertical direction and the extruding direction, and it becomes remarkably difficult to correct a shape of the deformed honeycomb formed body.

In the forming step, the inclination of the one row of the latticed slits 11a formed in the central portion 13 of the forming die 10 is preferably within the angle of ±10° to the vertical direction and more preferably within an angle of ±5° to the vertical direction. According to this constitution, it is possible to further decrease the deviation between each of the diameters of the central portion and circumferential portion of the honeycomb formed body and each standard value.

Hereinafter, description will be made as to the forming step of the manufacturing method of the present embodiment in more detail. As shown in FIG. 1 to FIG. 7, the forming step is a step of extruding the kneaded material 40 obtained by kneading the forming raw material from the kneaded material discharge surface 15 of the forming die 10 disposed in the horizontal forming machine 1, to obtain the round pillar-shaped honeycomb formed body 30. The honeycomb formed body 30 extruded in the horizontal direction is supported, for example, in a receiving base 25.

The forming die 10 is fixed by a die holder 22 in an outlet side end area of a cylinder 23 of the horizontal forming machine. The forming die 10 is constituted of a first die 16 to form the central portion 33 of the honeycomb formed body 30 and a second die 17 to form the circumferential portion 34 of the honeycomb formed body 30. In the first die 16, a kneaded material discharge surface 15a possesses a round shape corresponding to the central portion 33 of the honeycomb formed body 30, and in the second die 17, a kneaded material discharge surface 15b possesses a ring shape corresponding to the circumferential portion 34 of the honeycomb formed body 30. In FIG. 3, reference numeral 18 denotes a clearance area to form a boundary wall defining the central portion 33 and the circumferential portion 34 of the honeycomb formed body 30.

Here, description will be made as to a constitution of the forming die 10 shown in FIG. 5. The forming die 10 shown in FIG. 5 includes the first die 16, the second die 17, and a space forming member 20. The first die 16 is disposed on an upstream side of the extruding direction Z of the kneaded material as the forming raw material, and the central portion 13 on a kneaded material discharge surface 15 side has a convex section projecting toward a downstream side of the extruding direction Z. The second die 17 is a ring-shaped die disposed on the downstream side of the first die 16 and possessing a shape complementary to the convex section of the first die 16. The space forming member 20 is interposed between the first die 16 and the second die 17.

The space forming member 20 functions as a spacer to form a space between the surface of the first die 16 on the downstream side in the circumferential portion 14 and the surface of the second die 17 on the upstream side therein.

In the forming die 10, back holes 19 and the latticed slits 11a communicating with the back holes 19 are formed in the central portion 13 of the first die 16. The back holes 19 are formed coaxially with intersection points of the latticed slits 11a to the extruding direction Z. That is, the back holes 19 are formed along the extruding direction Z to communicate with the intersection points of the latticed slits 11a. Furthermore, in the first die 16, the back holes 19 are formed to extend through the circumferential portion 14 of the first die 16 in the circumferential portion 14 surrounding the central portion 13 of the first die 16.

In the ring-shaped second die 17, there are formed second back holes 19b into which the kneaded material discharged from the back holes 19 formed in the circumferential portion 14 of the first die 16 is introduced, and the latticed slits 11b communicating with the second back holes 19b. The second back holes 19b are formed coaxially with intersection points of the latticed slits 11b to the extruding direction Z. That is, the second back holes 19b are foamed along the extruding direction Z to communicate with the intersection points of the latticed slits 11b.

The forming die 10 is a die in which the first die 16 and the second die 17 are combined to hold the space forming member 20 therebetween. The space forming member 20 is disposed in an outer circumferential portion of a region where the second back holes 19b of the second die 17 are formed. Hereinafter, an end surface of the circumferential portion 14 of the first die 16 on the downstream side of the extruding direction Z will occasionally be referred to as “a downstream surface of the first die 16 in the circumferential portion 14”, and an end surface of the ring-shaped second die 17 on the upstream side of the extruding direction Z will occasionally be referred to as “the upstream surface of the second die 17”.

The forming die 10 has a space where movement of the kneaded material is performed between the back holes 19 and the second back holes 19b, between the downstream surface of the first die 16 in the circumferential portion 14 and the upstream surface of the second die 17. Consequently, for example, even when open positions of the back holes 19 formed in the circumferential portion 14 of the first die 16 are different from open positions of the second back holes 19b formed in the second die 17, the movement of the kneaded material is not obstructed in the forming die 10. Consequently, constantly uniform extrusion is achievable by the central portion 13 and the circumferential portion 14 of the forming die 10.

It is to be noted that in the manufacturing method of the present embodiment, there has been described an example where there is used the forming die 10 in which the space forming member 20 is interposed between the first die 16 and the second die 17 as described above, but the forming die 10 for use is not limited to such a constitution. Additionally, it is preferable to use such a die as described above in that the uniform extrusion is achievable by the central portion 13 and the circumferential portion 14 of the forming die 10.

Furthermore, although drawing is omitted, for example, “latticed grooves” may be provided in the surface of the second die 17 on the upstream side, in place of interposing the space forming member 20 between the first die 16 and the second die 17. Thus, the latticed grooves are provided, whereby the grooves provide an operation or an effect similar to that in the space formed by the space forming member 20, and the uniform extrusion is achievable. Additionally, in place of interposing the space forming member 20 between the first die 16 and the second die 17, a reticulated member may be interposed between the first die 16 and the second die 17. Thus, the reticulated member is provided, whereby meshes of the reticulated member provide an operation or an effect similar to that in the space formed by the space forming member 20, and the uniform extrusion is achievable. Furthermore, the forming die 10 is not limited to the constitution of the first die 16 and the second die 17 shown in the drawing, and there may be used, for example, a constitution in which slits different in shape between a central portion and a circumferential portion are formed to one die substrate.

An example of a material of the forming die 10 is a metal or an alloy which is usually used as a material of the honeycomb structure forming die. An example of the material of the forming die 10 is a metal or an alloy including at least one metal selected from the group consisting of iron (Fe), titanium (Ti), nickel (Ni), copper (Cu) and aluminum (Al).

In the forming die 10, each row consisting of the latticed slits 11a formed in the central portion 13 and each row consisting of the latticed slits 11b formed in the circumferential portion 14 may have a parallel positional relation, or do not have to have the parallel positional relation. The manufacturing method of the present embodiment is a manufacturing method which is effective especially when each row consisting of the latticed slits 11a formed in the central portion 13 and each row consisting of the latticed slits 11b formed in the circumferential portion 14 do not have the parallel positional relation. Specifically, in a conventional manufacturing method of the honeycomb structure, when performing extrusion by use of a forming die in which one type of latticed slits are formed, the extrusion is occasionally performed so that one row of the slits is oriented in the vertical direction. The reason is supposedly that roundness of a honeycomb formed body to be obtained improves. Therefore, it is considered that the extrusion is preferably similarly performed when performing the extrusion by use of the forming die in which two types of latticed slits are formed. In other words, in the case of taking the improvement of the roundness of the whole honeycomb formed body into consideration, it appears to be more preferable that the extrusion is performed to orient, in the vertical direction, one row of the latticed slits formed in the circumferential portion of the forming die. However, as a result of various studies, it has become clear that in the forming die in which two types of latticed slits are formed, the orientation of the slits of the central portion of the forming die has a larger influence on the dimensional differences from the standard values in the honeycomb formed body to be obtained. Therefore, in the case of using the forming die in which each row consisting of the slits formed in the central portion and each row consisting of the slits formed in the circumferential portion do not have the parallel positional relation, it is preferable to perform the extrusion on the basis of the orientation of the row of the latticed slits formed in the central portion.

In the forming die 10, one row of the latticed slits 11b formed in the circumferential portion 14 may be inclined at an angle in a range of 20 to 55° to the one row of the latticed slits 11a formed in the central portion 13. For example, in the forming die 10 shown in FIG. 3 and FIG. 4, one row of the latticed slits 11b formed in the circumferential portion 14 is inclined at an angle of 45° to one row of the latticed slits 11a formed in the central portion 13.

In the forming die 10 shown in FIG. 3 and FIG. 4, the respective slits 11a and 11b formed in the central portion 13 and the circumferential portion 14 are quadrangular lattices, but the respective slits 11a and 11b are not limited to the quadrangular lattices. However, when the arrangement made to orient the one row of the latticed slits 11a formed in the central portion 13 in the vertical direction is taken into consideration, it is preferable, that the slits 11a formed in the central portion 13 are the quadrangular lattices or hexagonal lattices. Furthermore, it is preferable that the slits 11b formed in the circumferential portion 14 are the quadrangular lattices or the hexagonal lattices.

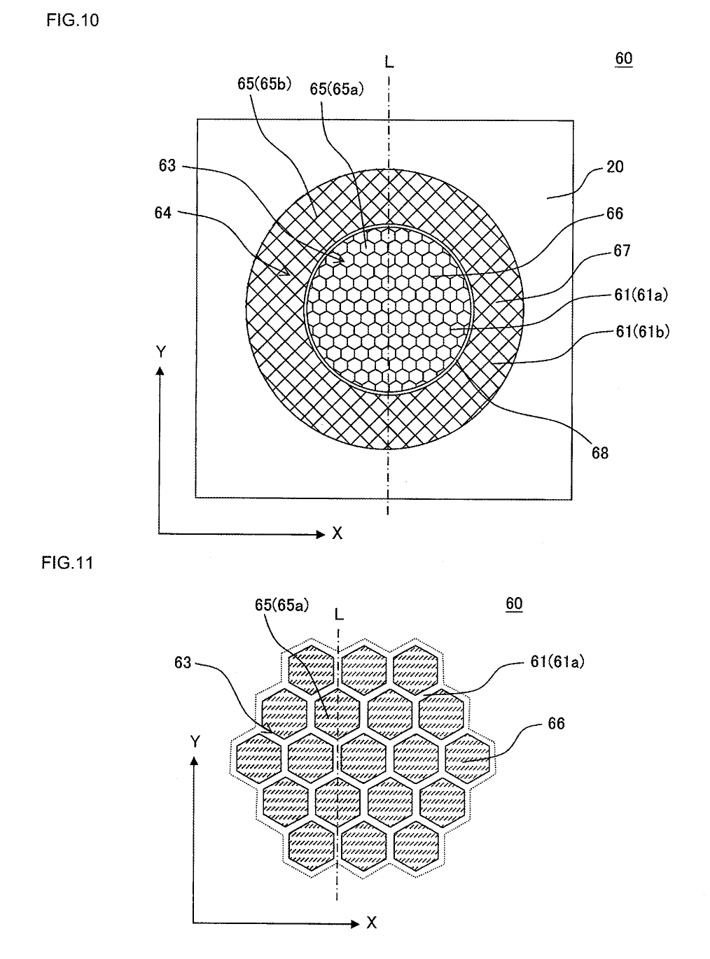

For example, a forming die 60 shown in FIG. 10 and FIG. 11 is constituted of a first die 66 and a second die 67. Latticed slits 61 are formed in kneaded material discharge surfaces 65 of the first die 66 and the second die 67, respectively. In the first die 66, a kneaded material discharge surface 65a possesses a round shape corresponding to a central portion of a honeycomb formed body and in the second die 67, a kneaded material discharge surface 65b possesses a ring shape corresponding to a circumferential portion of the honeycomb formed body. In the forming die 60, hexagonal latticed slits 61a are formed in a central portion 63 of the first die 66 and quadrangular latticed slits 61b are formed in a circumferential portion 64 consisting of the second die 67. In FIG. 10, reference numeral 68 denotes a clearance area to form a boundary wall defining the central portion 33 and the circumferential portion 34 of the honeycomb formed body 30. FIG. 10 is a front view schematically showing the forming die for use in a forming step in another embodiment of the manufacturing method of the honeycomb structure of the present invention. FIG. 11 is an enlarged front view in which the central portion of the forming die shown in FIG. 10 is enlarged.

The forming die 60 is also disposed in an orientation in which an inclination of one row of the hexagonal latticed slits 61a formed in the central portion 63 is within an angle ±10° to a vertical direction, to perform extrusion. According to such a constitution, the extrusion can be performed to further decrease a dimensional difference (i.e., deviation) between each of diameters of the central portion and circumferential portion of the honeycomb formed body and each standard value. In FIG. 10 and FIG. 11, a one-dot chain line denoted with symbol L indicates an extending direction of one row of the hexagonal latticed slits 61a of the central portion 63 (i.e., an orientation of one row of the slits 61a of the central portion 63).

Furthermore, a size ratio of an outer diameter of the central portion in a kneaded material discharge surface to a diameter of an end face of the honeycomb formed body to be extruded is suitably determined in accordance with a constitution of the honeycomb formed body to be extruded. Additionally, in the forming die, the size ratio of the outer diameter of the central portion in the kneaded material discharge surface to the diameter of the end face of the honeycomb formed body to be extruded is preferably 50% or more and especially preferably from 60 to 80%. According to this constitution, it is possible to perform the extrusion so that a dimensional difference between each of the diameters of the central portion and circumferential portion of the honeycomb formed body and each standard value further decreases. For example, when the size ratio of the outer diameter of the central portion in the kneaded material discharge surface of the forming die to the diameter of the end face of the honeycomb formed body is smaller than 50%, it might become hard to obtain the effect of inhibiting the deformation or distortion of the honeycomb formed body.

In the forming die, it is preferable that a lattice interval in the slits formed in the central portion is smaller than a lattice interval in the slits formed in the circumferential portion. It is to be noted that in the forming die, the lattice interval in the slits formed in the central portion may be larger than the lattice interval in the slits formed in the circumferential portion, and the respective intervals may be the same. When the lattice interval in the slits formed in the central portion is smaller than the lattice interval in the slits formed in the circumferential portion, the effect of inhibiting the deformation or distortion of the honeycomb formed body more suitably develops.

As shown in FIG. 1 and FIG. 2, in the forming die 10, a pressing plate 21 is disposed on the kneaded material discharge surface 15 side of the forming die 10. The pressing plate 21 is a ring-shaped member in which there is formed an open end to determine a shape and a dimension of a cross section of the honeycomb formed body 30 to be obtained by the extrusion which is perpendicular to an axial direction (i.e., the extruding direction Z).

The receiving base 25 is disposed to support the extruded honeycomb formed body 30, and has a support surface 26 which comes in contact with a circumferential face of the honeycomb formed body 30 during the supporting. The support surface 26 is formed along a cross-sectional shape of the cross section of the honeycomb formed body 30 which is perpendicular to the axial direction of the honeycomb formed body 30. For example, the receiving base 25 shown in FIG. 6 is an example of a receiving base in which the support surface 26 having a circular cross section is formed to support the honeycomb formed body having a round cross-sectional shape of the cross section perpendicular to the axial direction. For example, the receiving base 25 is conveyed by horizontal conveying means such as a conveyor 27 in a state of supporting the extruded honeycomb formed body 30. FIG. 7 shows the honeycomb formed body 30 in a state after the honeycomb formed body is extruded and then cut into a predetermined length in a cutting step.

There are not any special restrictions on a preparing method of the kneaded material 40 to form the honeycomb formed body 30, and the method can be performed in conformity with the heretofore known manufacturing method of the honeycomb structure. There are not any special restrictions on a forming raw material for use in the kneaded material 40, but examples of the material include cordierite, a cordierite forming raw material, silicon carbide, aluminum titanate, silicon nitride, mullite, and alumina. It is to be noted that “the cordierite forming raw material” is a ceramic raw material blended to obtain a chemical composition in which silica falls in a range of 42 to 56 mass %, alumina falls in a range of 30 to 45 mass %, and magnesia falls in a range of 12 to 16 mass %. The cordierite forming raw material is fired to form cordierite.

Furthermore, the forming raw material contains water that serves as a dispersing medium. Additionally, the forming raw material may contain a pore former, a binder, a surfactant and the like as required. In particular, when the honeycomb formed body 30 is for use in a filter such as a DPF, a performance of the filter changes in accordance with a porosity or pore diameters after the firing, and hence it is preferable to control the porosity or the pore diameters after the firing by containing the pore former in the forming raw material.

As described above, the firing step can be performed in conformity with a firing step in the heretofore known manufacturing method of the honeycomb structure. Furthermore, the obtained honeycomb formed body may be dried, for example, with microwaves and hot air prior to performing the firing step. A firing temperature and a firing atmosphere vary in accordance with the raw material, and a person skilled in the art can select the firing temperature and the firing atmosphere which are most suitable for the selected material.

Next, description will be made as to the honeycomb structure to be manufactured by the manufacturing method of the present embodiment. FIG. 8 is a perspective view schematically showing the honeycomb structure manufactured by the one embodiment of the manufacturing method of the honeycomb structure of the present invention. FIG. 9 is a plan view schematically showing an inflow end face of the honeycomb structure shown in FIG. 8.

The honeycomb structure 50 shown in FIG. 8 and FIG. 9 include porous partition walls 51 and a circumferential wall 57 disposed to surround a circumference of the partition walls 51. The partition walls 51 define and form a plurality of cells 52 extending from a first end face 55 to a second end face 56 and forming through channels for fluid. Then, the honeycomb structure 50 has different cell structures in a central portion 53 and a circumferential portion 54. A boundary between the central portion 53 and the circumferential portion 54 of the honeycomb structure 50 has a boundary wall 58 made of the same material as in the partition walls 51. It is to be noted that the honeycomb structure 50 may or does not have to have the boundary wall 58.

The cell structure of the central portion 53 of the honeycomb structure 50 is a cell structure constituted of a plurality of cells 52a formed in the central portion in a plane of the honeycomb structure 50 which is perpendicular to an extending direction of the cells 52. Furthermore, the cell structure of the circumferential portion 54 of the honeycomb structure 50 is a cell structure constituted of a plurality of cells 52b formed in the circumferential portion in the plane of the honeycomb structure 50 which is perpendicular to the extending direction of the cells 52.

The honeycomb structure 50 shown in FIG. 8 and FIG. 9 is one example of the honeycomb structure manufactured by the manufacturing method of the present embodiment, and a shape or the like of the cells 52 defined by the porous partition walls 51 is suitably changeable in accordance with a use application of the honeycomb structure to be manufactured.

### EXAMPLES

Hereinafter, examples of the present invention will further specifically be described, but the present invention is not restricted by these examples.

### Example 1

In Example 1, a honeycomb structure was manufactured by using a forming die 10 in which one row of latticed slits 11b formed in a circumferential portion 14 was inclined at 45° to one row of latticed slits 11a formed in a central portion 13 as shown in FIG. 3 and FIG. 4.

The honeycomb structure as a final product had a round pillar shape in which a diameter of each end face was 100 mm, and a diameter of a cell structure of a central portion in the end face was 70 mm. A boundary between the cell structure of the central portion and a cell structure of a circumferential portion had a boundary wall having a thickness of 0.1 mm. A value of a diameter of the cell structure of the above-mentioned central portion included this thickness of the boundary wall. In the cell structure of the central portion, a cell shape was quadrangular, a partition wall thickness was 0.09 mm, and a cell density was 93 cells/cm². In the cell structure of the circumferential portion, a cell shape was quadrangular, a partition wall thickness was 0.11 mm, and a cell density was 62 cells/cm². This honeycomb structure had the cell structure in which an arrangement direction of quadrangular cells of the central portion intersected an arrangement direction of cells of the circumferential portion at an angle of 45° in a cross section of the honeycomb structure which was perpendicular to an extending direction of the cells. The diameter of 100 mm of the end face of the honeycomb structure as the above-mentioned final product and the diameter of 70 mm of the cell structure of the central portion were defined as “standard values” in Example 1.

In Example 1, there was prepared the die in which the slits corresponding to the above-mentioned shape of the honeycomb structure were formed, extrusion was performed by using a kneaded material prepared by the following method, and an obtained honeycomb formed body was fired to manufacture the honeycomb structure. In Example 1, there were manufactured 200 honeycomb structures. In a forming step, the forming die was disposed in an orientation in which one row of latticed slits formed in the central portion of the forming die was parallel to a vertical direction, to extrude the kneaded material in a horizontal direction.

### Preparing Method of Kneaded Material

The preparation of the kneaded material was performed by using a cordierite forming raw material as a forming raw material. Specifically, 5 parts by mass of a pore former, 85 parts by mass of a dispersing medium and 8 parts by mass of an organic binder were added to 100 parts by mass of the cordierite forming raw material, and mixed and kneaded to prepare the kneaded material. As the cordierite forming raw material, alumina, aluminum hydroxide, kaolin, talc and silica were used. Water was used as the dispersing medium, a water absorbable polymer having an average particle diameter of 100 to 105 μm was used as the pore former, methylcellulose was used as the organic binder, and 3 parts by mass of a surfactant was used as a dispersing agent.

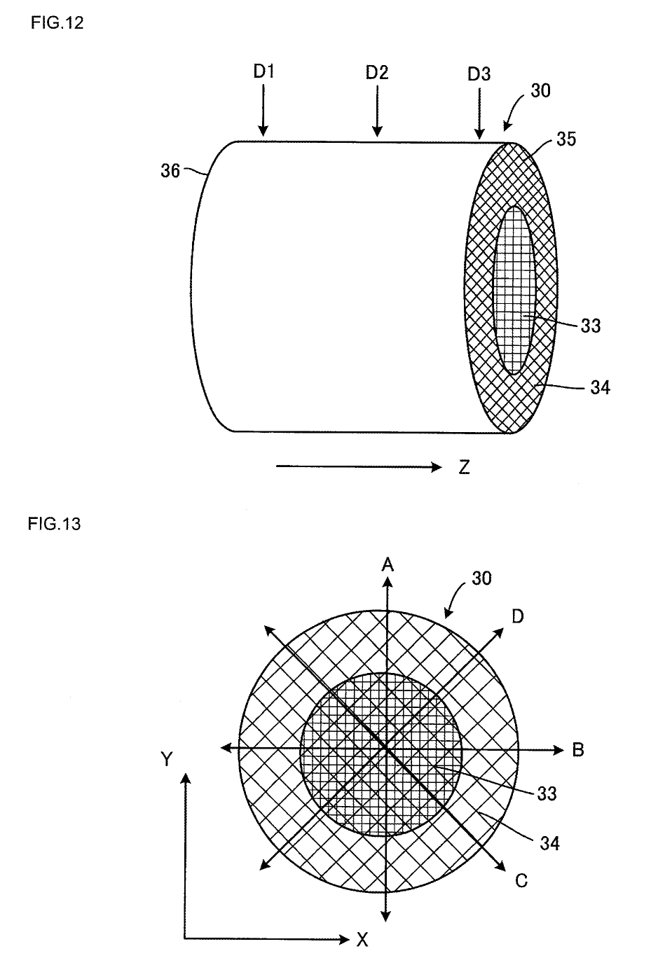

In Example 1, as to the honeycomb formed body obtained by the extrusion, an outer diameter of the circumferential portion and an outer diameter of the central portion were measured in a measurement region mentioned below. Specifically, as to the honeycomb formed body obtained by the extrusion, there were measured the outer diameter of the circumferential portion and the outer diameter of the central portion in cross sections cut in three arrow directions D1, D2 and D3 shown in FIG. 12.

The outer diameter of the circumferential portion corresponded to an outer diameter of the honeycomb formed body, and the outer diameter of the central portion corresponded to an outer diameter of the boundary wall defining the circumferential portion and the central portion. In FIG. 12, D1 is a position of 1 mm from a second end face 36 of a honeycomb formed body 30. D2 is an intermediate point between the second end face 36 and a first end face 35 of the honeycomb formed body 30. D3 is a position of 1 mm from the first end face 35 of the honeycomb formed body 30. Furthermore, as to three cross sections cut in the three arrow directions denoted with D1, D2 and D3, respective dimensions were measured in four directions as shown in FIG. 13. Specifically, the respective dimensions were measured in the four directions of a vertical direction A, a horizontal direction B, a depression direction C from the horizontal direction toward the downside at an angle of 45° and an elevation direction D from the horizontal direction toward the upside at an angle of 45°. Table 1 shows the measurement results. The result shown in Table 1 is an average value of the measurement results of 20 honeycomb formed bodies. Table 1 shows, in a column of a “circumferential portion”, values of the outer diameters of the circumferential portions which were measured at measurement points of FIG. 12 and FIG. 13. Furthermore, Table 1 shows, in a column of a “central portion”, values of the outer diameters of the central portions which were measured at the measurement points of FIG. 12 and FIG. 13.

Here, FIG. 12 shows a schematic perspective view of the honeycomb formed body to explain the measurement region of the outer diameter of the circumferential portion and the outer diameter of the central portion in the honeycomb formed body. FIG. 13 is a cross-sectional view showing a cross section of the honeycomb formed body shown in FIG. 12 which is perpendicular to a cell extending direction.

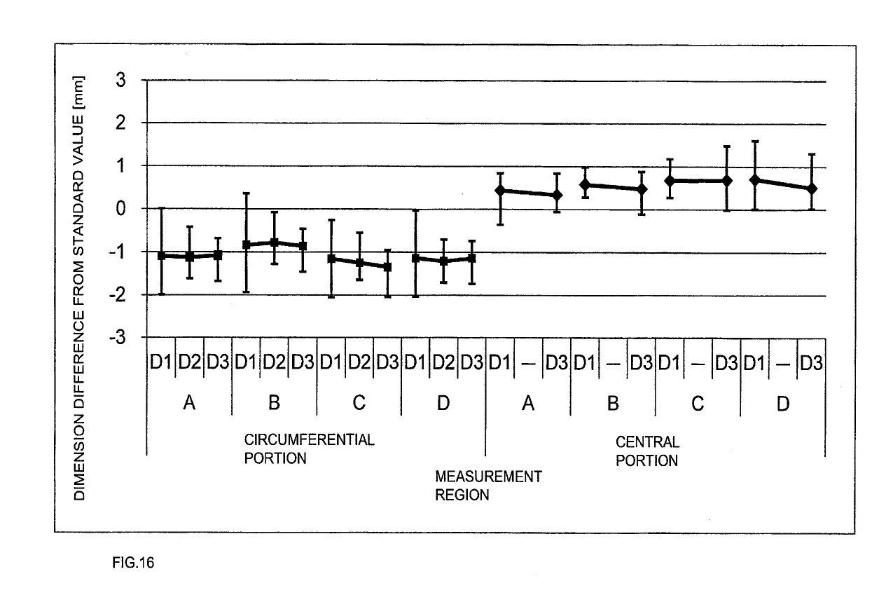

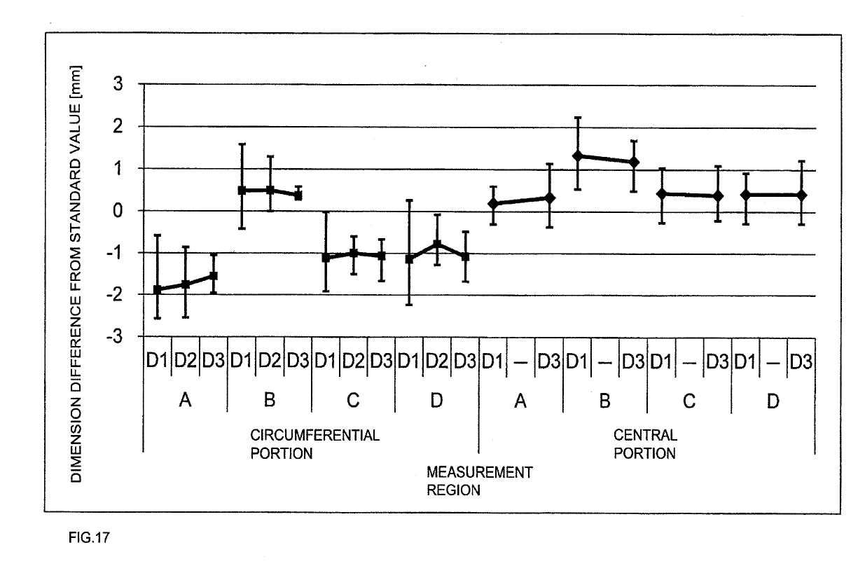

Furthermore, there was calculated a difference between each of the outer diameter of the circumferential portion and the outer diameter of the central portion which were measured by the above-mentioned method and each standard value. Additionally, there were also calculated “a difference (mm) between a maximum value and an average value” and “a difference (mm) between the average value and a minimum value”. Table 1 shows the results. Furthermore, on the basis of the above results, there was prepared a graph showing dimensional differences from the standard values in the honeycomb formed body extruded in the manufacturing method of the honeycomb structure of Example 1. FIG. 16 shows the prepared graph. FIG. 16 is the graph showing the dimensional differences from the standard values in the honeycomb formed body extruded in the manufacturing method of the honeycomb structure of Example 1.

TABLE 1

| | | | Difference | Difference | Difference |
|---|---|---|---|---|---|
| | | | between | between | between |
| | | | average value | maximum value | average value |
| | | | and standard | and average | and minimum |
| | | | value | value | value |
| Measurement region | | | (mm) | (mm) | (mm) |
| Circum- | A | D1 | −1.09 | 1.1 | 0.9 |
| ferential | | D2 | −1.12 | 0.7 | 0.5 |
| portion | | D3 | −1.08 | 0.4 | 0.6 |
| | B | D1 | −0.835 | 1.2 | 1.1 |
| | | D2 | −0.78 | 0.7 | 0.5 |
| | | D3 | −0.86 | 0.4 | 0.6 |
| | C | D1 | −1.156 | 0.9 | 0.9 |
| | | D2 | −1.251 | 0.7 | 0.4 |
| | | D3 | −1.349 | 0.4 | 0.7 |
| | D | D1 | −1.135 | 1.1 | 0.9 |
| | | D2 | −1.206 | 0.5 | 0.5 |
| | | D3 | −1.139 | 0.4 | 0.6 |
| Central | A | D1 | 0.445 | 0.4 | 0.8 |
| portion | | — | — | — | — |
| | | D3 | 0.345 | 0.5 | 0.4 |
| | B | D1 | 0.585 | 0.4 | 0.3 |
| | | — | — | — | — |
| | | D3 | 0.485 | 0.4 | 0.6 |
| | C | D1 | 0.68 | 0.5 | 0.4 |
| | | — | — | — | — |
| | | D3 | 0.69 | 0.8 | 0.7 |
| | D | D1 | 0.712 | 0.9 | 0.7 |
| | | — | — | — | — |
| | | D3 | 0.514 | 0.8 | 0.5 |

### Comparative Example 1

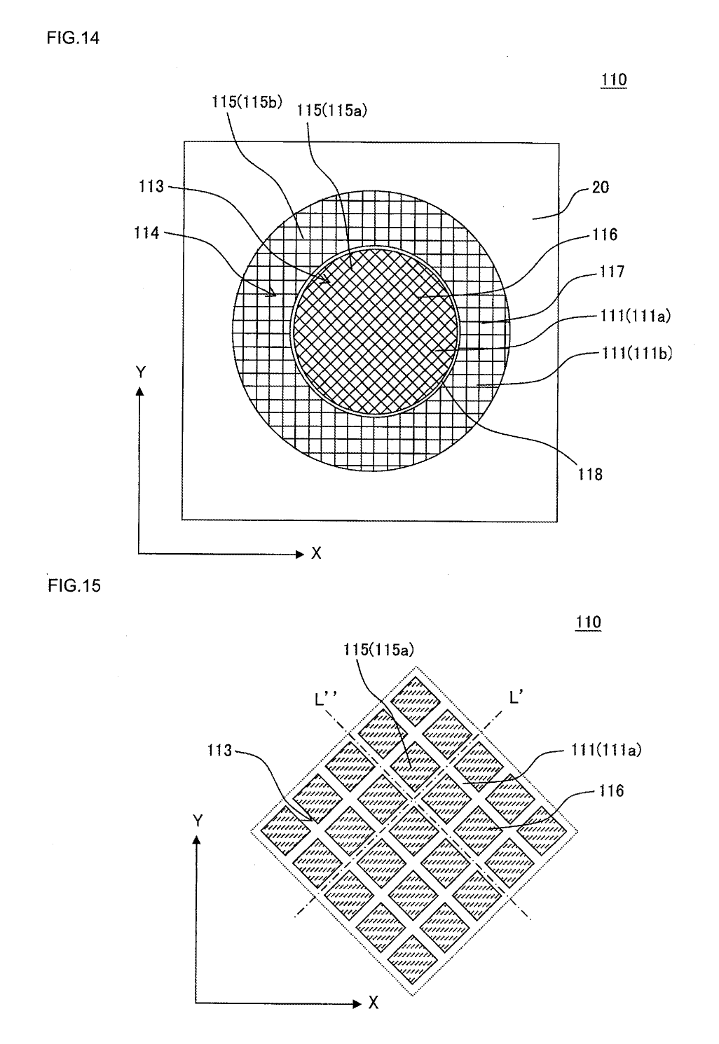

In Comparative Example 1, a kneaded material prepared by a method similar to Example 1 was extruded by using such a forming die 110 as shown in FIG. 14 and FIG. 15 to prepare a honeycomb formed body. FIG. 14 is a front view schematically showing the forming die for use in a forming step of a manufacturing method of a honeycomb structure of Comparative Example 1. FIG. 15 is an enlarged front view in which a central portion of the forming die shown in FIG. 14 is enlarged.

The forming die 110 shown in FIG. 14 and FIG. 15 is constituted of a first die 116 and a second die 117. Latticed slits 111 are formed in kneaded material discharge surfaces 115 of the first die 116 and the second die 117, respectively. In the first die 116, a kneaded material discharge surface 115a possesses a round shape corresponding to a central portion of the honeycomb formed body, and in the second die 117, a kneaded material discharge surface 115b possesses a ring shape corresponding to a circumferential portion of the honeycomb formed body. In the forming die 110, quadrangular latticed slits 111a are formed in a central portion 113 of the first die 116, and quadrangular latticed slits 111b are also formed in a circumferential portion 114 consisting of the second die 117. In FIG. 14, reference numeral 118 denotes a clearance area to form a boundary wall defining the central portion and circumferential portion of the honeycomb formed body.

In a forming step of Comparative Example 1, as shown in FIG. 14 and FIG. 15, the forming die 110 was disposed so that one row of the latticed slits 111a formed in the central portion 113 of the forming die 110 was inclined at 45° to a vertical direction, to extrude the kneaded material in a horizontal direction. In this forming step, one row of the latticed slits 111b formed in the circumferential portion 114 of the forming die 110 was parallel to the vertical direction. In FIG. 14 and FIG. 15, one-dot chain lines denoted with symbols L′ and L″ indicate extending directions of one row of the quadrangular latticed slits 111a of the central portion 113 (i.e., an orientation of each row of the slits 111a of the central portion 113).

Also in Comparative Example 1, as to the honeycomb formed body obtained by the extrusion, an outer diameter of the circumferential portion and an outer diameter of the central portion were measured by a method similar to Example 1. Furthermore, there was calculated a difference between each of measured values of the outer diameter of the circumferential portion and the outer diameter of the central portion and each standard value. Furthermore, “a difference (mm) between a maximum value and an average value” and “a difference (mm) between the average value and a minimum value” were also calculated, respectively. Table 2 shows the results.

TABLE 2

| | | | Difference | Difference | Difference |
|---|---|---|---|---|---|
| | | | between | between | between |
| | | | average value | maximum value | average value |
| | | | and standard | and average | and minimum |
| | | | value | value | value |
| Measurement region | | | (mm) | (mm) | (mm) |
| Circum- | A | D1 | −1.88 | 1.3 | 0.7 |
| ferential | | D2 | −1.76 | 0.9 | 0.8 |
| portion | | D3 | −1.55 | 0.5 | 0.4 |
| | B | D1 | 0.485 | 1.1 | 0.9 |
| | | D2 | 0.495 | 0.8 | 0.5 |
| | | D3 | 0.38 | 0.2 | 0.1 |
| | C | D1 | −1.115 | 1.1 | 0.8 |
| | | D2 | −0.995 | 0.4 | 0.5 |
| | | D3 | −1.065 | 0.4 | 0.6 |
| | D | D1 | −1.135 | 1.4 | 1.1 |
| | | D2 | −0.775 | 0.7 | 0.5 |
| | | D3 | −1.075 | 0.6 | 0.6 |
| Central | A | D1 | 0.2 | 0.4 | 0.5 |
| portion | | — | | | |
| | | D3 | 0.335 | 0.8 | 0.7 |
| | B | D1 | 1.335 | 0.9 | 0.8 |
| | | — | | | |
| | | D3 | 1.19 | 0.5 | 0.7 |
| | C | D1 | 0.44 | 0.6 | 0.7 |
| | | — | | | |
| | | D3 | 0.39 | 0.7 | 0.6 |
| | D | D1 | 0.42 | 0.5 | 0.7 |
| | | — | | | |
| | | D3 | 0.42 | 0.8 | 0.7 |

Furthermore, on the basis of the above results, there was prepared a graph showing dimensional differences from the standard values in the honeycomb formed body extruded in the manufacturing method of the honeycomb structure of Comparative Example 1. FIG. 17 shows the prepared graph. FIG. 17 is the graph showing the dimensional differences from the standard values in the honeycomb formed body extruded in the manufacturing method of the honeycomb structure of Comparative Example 1.

### Result

In a honeycomb formed body extruded by a manufacturing method of a honeycomb structure of Example 1, “a difference between an average value and a standard value” indicated comparatively uniform values in four directions of a vertical direction A, a horizontal direction B, a depression direction C and an elevation direction D of FIG. 13. On the other hand, in a honeycomb formed body extruded by a manufacturing method of a honeycomb structure of Comparative Example 1, “a difference between an average value and a standard value” had a larger deviation than in Example 1. Furthermore, the honeycomb formed body extruded by the manufacturing method of the honeycomb structure of Example 1 also indicated comparatively uniform values in three cross sections cut in three arrow directions denoted with D1, D2 and D3 of FIG. 12. On the other hand, in the honeycomb formed body extruded by the manufacturing method of the honeycomb structure of Comparative Example 1, values in the above three cross sections also had larger deviations than in Example 1.

As seen from the above results, according to the manufacturing method of the honeycomb structure of Example 1, it was possible to manufacture a honeycomb structure having an excellent shape accuracy. Furthermore, in manufacturing methods other than the manufacturing method of Example 1, it has been confirmed that a difference between an average value and a standard value decreases in the same manner as in Example 1, when an inclination of one row of latticed slits formed in a central portion is within an angle of ±10° to a vertical direction.

A manufacturing method of a honeycomb structure of the present invention is utilizable as a method of manufacturing a honeycomb structure for use as an exhaust gas purifying filter or catalyst carrier.

### DESCRIPTION OF REFERENCE NUMERALS

1: horizontal forming machine, 10, 60 and 110: forming die, 11, 61 and 111: slit, 11a, 61a and 111a: slit (slits of a central portion), 11b, 61b and 111b: slit (slits of a circumferential portion), 13, 63 and 113: central portion, 14, 64 and 114: circumferential portion, 15, 65 and 115: kneaded material discharge surface, 15a, 65a and 115a: kneaded material discharge surface (the kneaded material discharge surface of a first die), 15b, 65b and 115b: kneaded material discharge surface (the kneaded material discharge surface of a second die), 16, 66 and 116: first die, 17, 67 and 117: second die, 18, 68 and 118: clearance area (the clearance area to form a boundary wall), 19: back hole, 19b: second back hole, 20: space forming member, 21: pressing plate, 22: die holder, 23: cylinder of the horizontal forming machine, 25: receiving base, 26: support surface (the support surface of the receiving base), 27: conveyor, 30: honeycomb formed body, 31: partition wall, 31a: partition wall (partition walls of a central portion), 31b: partition wall (partition walls of a circumferential portion), 32: cell, 32a: cell (cells of the central portion), 32b: cell (cells of the circumferential portion), 33: central portion (the central portion of a honeycomb formed body), 34: circumferential portion (the circumferential portion of the honeycomb formed body), 35: first end face, 36: second end face, 40: kneaded material, 50: honeycomb structure, 51: partition wall, 51a: partition wall (partition walls of the central portion), 51b: partition wall (partition walls of the circumferential portion), 52: cell, 52a: cell (cells of the central portion), 52b: cell (cells of the circumferential portion), 53: central portion (the central portion of a honeycomb structure), 54: circumferential portion (the circumferential portion of the honeycomb structure), 55: first end face, 56: second end face, 57: circumferential wall, 58: boundary wall, L, L′ and L″: orientation of one row of the slits of the central portion, X: direction perpendicular to a vertical direction and an extruding direction, Y: vertical direction, and Z: extruding direction.

What is claimed is:

1. A manufacturing method of a honeycomb structure, comprising:
a forming step of extruding a kneaded material including a forming raw material by use of a horizontal forming machine comprising a forming die in which latticed slits are formed in a kneaded material discharge surface, to obtain a round pillar-shaped honeycomb formed body having latticed partition walls; and
a firing step of firing the obtained honeycomb formed body to prepare the honeycomb structure,
wherein in the forming step, there is used the forming die in which there are formed the slits different in lattice shape between a central portion and a circumferential portion in the kneaded material discharge surface, and
the forming die is disposed in an orientation in which an inclination of one row of the latticed slits formed in the central portion is within an angle of ±10° to a vertical direction, to extrude the kneaded material in a horizontal direction.

2. The manufacturing method of the honeycomb structure according to claim 1,
wherein in the forming die, each row consisting of the latticed slits formed in the central portion and each row consisting of the latticed slits formed in the circumferential portion do not have a parallel positional relation.

3. The manufacturing method of the honeycomb structure according to claim 1,
wherein in the forming die, the slits formed in the central portion are quadrangular lattices or hexagonal lattices.

4. The manufacturing method of the honeycomb structure according to claim 1,
wherein in the forming die, the slits formed in the circumferential portion are quadrangular lattices or hexagonal lattices.

5. The manufacturing method of the honeycomb structure according to claim 4,
wherein in the forming die, one row of the latticed slits formed in the circumferential portion is inclined at an angle in a range of 20 to 55° to one row of the latticed slits formed in the central portion.

6. The manufacturing method of the honeycomb structure according to claim 1,
wherein in the forming die, a size ratio of an outer diameter of the central portion in the kneaded material discharge surface to a diameter of an end face of the honeycomb formed body to be extruded is from 60 to 80%.

7. The manufacturing method of the honeycomb structure according to claim 1,
wherein in the forming die, a lattice interval in the slits formed in the central portion is smaller than a lattice interval in the slits formed in the circumferential portion.
